(19) United States
(12) Patent Application Publication
(10) Pub. No.: US 2010/0069143 A1
(43) Pub. Date: Mar. 18, 2010

(54) GAMING CONTROLLER, DEVICE AND METHOD OF GAMING

(75) Inventor: Billy Ho Ching Tam, East Killara (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY LIMITED, Lane Cove, NSW (AU)

(21) Appl. No.: 12/210,692

(22) Filed: Sep. 15, 2008

(51) Int. Cl. A63F 13/10

(52) U.S. Cl. 463/25

(57) ABSTRACT

A method of gaming comprises determining a number of gaming devices that meet a participation criterion. Award outcomes of at least one gaming device which meets the participation criterion are adjusted dependent, at least in part, on the determined number.

### CROSS-REFERENCE TO RELATED APPLICATIONS/INCORPORATED BY REFERENCE

Not Applicable

### FEDERALLY SPONSORED RESEARCH OR DEVELOPMENT

Not Applicable

### FIELD OF THE INVENTION

The present invention relates to a gaming controller, a gaming device and method of gaming.

### BACKGROUND OF THE INVENTION

Many venues employ controllers for awarding prizes to one or more of a plurality of gaming devices participating in a linked event. For example, in a linked event where jackpot prizes are awarded, a portion of turnover on each gaming device will typically be forwarded to a jackpot controller as a contribution. That is, part of each wager goes towards the jackpot. The technique can be extended to a so called wide area jackpot where gaming devices from a number of different venues contribute to a single jackpot pool.

While such techniques provide an opportunity for players to win large jackpot prizes, the need exists for alternative gaming systems in order to maintain or increase player enjoyment. It would also be advantageous if there was provided a gaming system for increasing the social interaction between players.

### SUMMARY OF THE INVENTION

In a first aspect there is provided a method of gaming comprising:

determining a number of gaming devices that meet a participation criterion; and

adjusting award outcomes of at least one gaming device which meets the participation criterion dependent, at least in part, on the determined number.

In an embodiment award outcomes are adjusted by adjusting one of an expected return to player of the gaming device and a probability of at least one game outcome.

In the context of the present specification the phrase “return to player” is to be given its plain and ordinary meaning; that is any measure of the value of prizes awarded by a game as a percentage of all bets made.

In an embodiment the return to player is adjusted by implementing a prize table which corresponds to the determined number of gaming devices.

In an embodiment the probability of achieving the at least one game outcome is increased responsive to the number of gaming machines increasing.

In an embodiment adjusting award outcomes comprises enabling the gaming device to receive a bonus award from a bonus controller.

In an embodiment the bonus award is awarded responsive to determining that another one of the gaming devices has triggered a bonus prize trigger.

In an embodiment the bonus award takes the form of at least one of bonus credits, free games, feature games and coupons.

In an embodiment adjusting award outcomes comprises adjusting a bonus award the gaming device may receive from a bonus controller

In an embodiment the participation criterion is that at least one game has been played within a specified time period.

In an embodiment the participation criterion further requires that a current wager amount of the gaming device exceeds a threshold.

In an embodiment the method comprises repeating the step of determining whether to adjust the award outcome each time a new game is played by the at least one gaming device.

In an embodiment the gaming devices are located within either a specified region or number of machines adjacent the at least one gaming device.

In accordance with a second aspect of the present invention there is provided a controller comprising:

a determining module arranged to determine a number of gaming devices which meet a participation criterion; and

an adjustment module arranged to adjust award outcomes of at least one gaming device which meets the participation criterion dependent, at least in part, on the determined number of gaming devices.

In an embodiment the adjustment module adjusts award outcomes by adjusting one of an expected return to player of the gaming device and a probability of at least one game outcome.

In an embodiment the return to player is adjusted by implementing a prize table which corresponds to the determined number of gaming devices.

In an embodiment the adjustment module increases the probability of achieving the at least one game outcome responsive to the number of gaming devices increasing.

In an embodiment adjusting award outcomes comprises adjusting a bonus award the gaming device may receive from a bonus controller.

In a third aspect, there is provided a gaming device operable to communicate with other gaming devices over a communications network, the gaming device comprising:

a determining module arranged to determine a number of the other gaming devices which meet a participation criterion; and

an adjustment module arranged to adjust an award outcome of the gaming device dependent, at least in part, on the determined number of gaming devices.

In a fourth aspect, there is provided a gaming system comprising a controller in accordance with the second aspect.

In a fifth aspect, there is provided a method of gaming comprising the steps of:

determining whether play of a game facilitated by a gaming device meets a participation criterion;

responsive to making a positive determination, outputting a notification signal indicating that the gaming device meets the participation criterion; and

adjusting a characteristic of the game based, at least in part, on a number of the other gaming devices that also meet the participation criterion, the number being derived from notification signals output from the other gaming devices.

In an embodiment the gaming device is arranged to processes the notification signals to derive the number.

In an embodiment the gaming device is arranged to receive data indicative of either the derived number or an adjustment amount from a controller, in order to adjust the characteristic.

In an embodiment the characteristic of the game comprises a statistical return to player.

In a sixth aspect, there is provided a gaming device comprising:

a game control system arranged to execute game software so as to facilitate play of a game; and

a game adjustment module arranged to:

determine whether play of the game meets a participation criterion; responsive to making a positive determination, output a notification signal indicating that the gaming device meets the participation criterion; and adjust a characteristic of the game based, at least in part, on a number of the other gaming devices that meet the participation criterion, the number being derived from notification signals output from the other gaming devices.

In an embodiment the adjustment module is arranged to processes the notification signals to derive the number.

In an embodiment the game adjustment module is arranged to receive data indicative of either the derived number or an adjustment amount from a controller, in order to adjust the characteristic.

In accordance with a seventh aspect, the present invention provides computer program code which when executed by a processor implements any one of the above method aspects.

In accordance with an eighth aspect, the present invention provides a computer readable medium providing a computer program in accordance with the seventh aspect.

In accordance with a ninth aspect there is provided a data signal comprising the program code of the seventh aspect.

### BRIEF DESCRIPTION OF THE DRAWINGS

Features and advantages of the present invention will become apparent from the following description of embodiments thereof, by way of example only, with reference to the accompanying drawings, in which:

FIG. 1 is a block diagram of a gaming system;

FIG. 2 is a perspective view of a gaming device in the form of a stand alone gaming machine;

FIG. 3 is a block diagram of the functional components of the gaming machine of FIG. 2;

FIG. 4 is a block diagram representing the structure of a memory;

FIG. 5 is a block diagram of a controller;

FIG. 6 is a schematic showing an example implementation of a group of gaming devices, in accordance with an embodiment of the present invention; and

FIG. 7 is a flow diagram of an embodiment.

### DETAILED DESCRIPTION

Referring to the drawings there is shown a game controller comprising a determining module arranged to determine a number of gaming devices which meet a participation criterion. An adjustment module adjusts an award outcome of at least one gaming device meeting the participating criterion dependent, at least in part, on the determined number of gaming devices which meet the participation criterion.

### General System Configuration

In the gaming system configuration 100, a jackpot controller 110 is in data communication with a plurality of gaming devices 120 over a network 130. The gaming devices 120 are arranged in two banks (103a and 103b) of two gaming machines 120. A person skilled in the art will also appreciate that other configurations may be viable.

### Gaming Devices

Herein, the term gaming device is used to refer to any device used by a player to a play a game and specifically includes stand alone gaming machines and interactive video terminals which implement games in a client/server architecture.

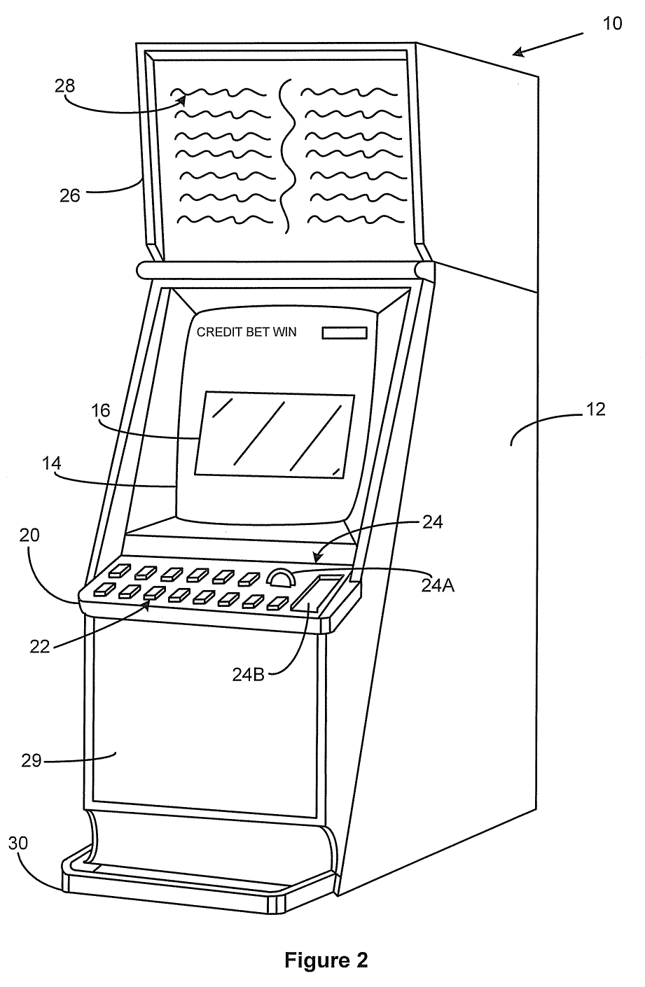

A gaming device in the form of a stand alone gaming machine 10 is illustrated in FIG. 2. The gaming machine 10 includes a cabinet 12 having a display 14 on which is displayed representations of a game 16 that can be played by a player. A mid-trim 20 of the gaming machine 10 houses a bank of buttons 22 for enabling a player to interact with the gaming machine 10, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module comprising a reading device may also be provided for the purpose of reading a player tracking device, for example as part of a loyalty program. The player tracking device may be in the form of a card, flash drive or any other portable storage medium capable of being read by the reading device.

A top box 26 may carry static artwork 28, including for example pay tables and details of bonus awards and other information or images relating to the game 16. Further artwork and/or information may be provided on a front panel 29 of the cabinet 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

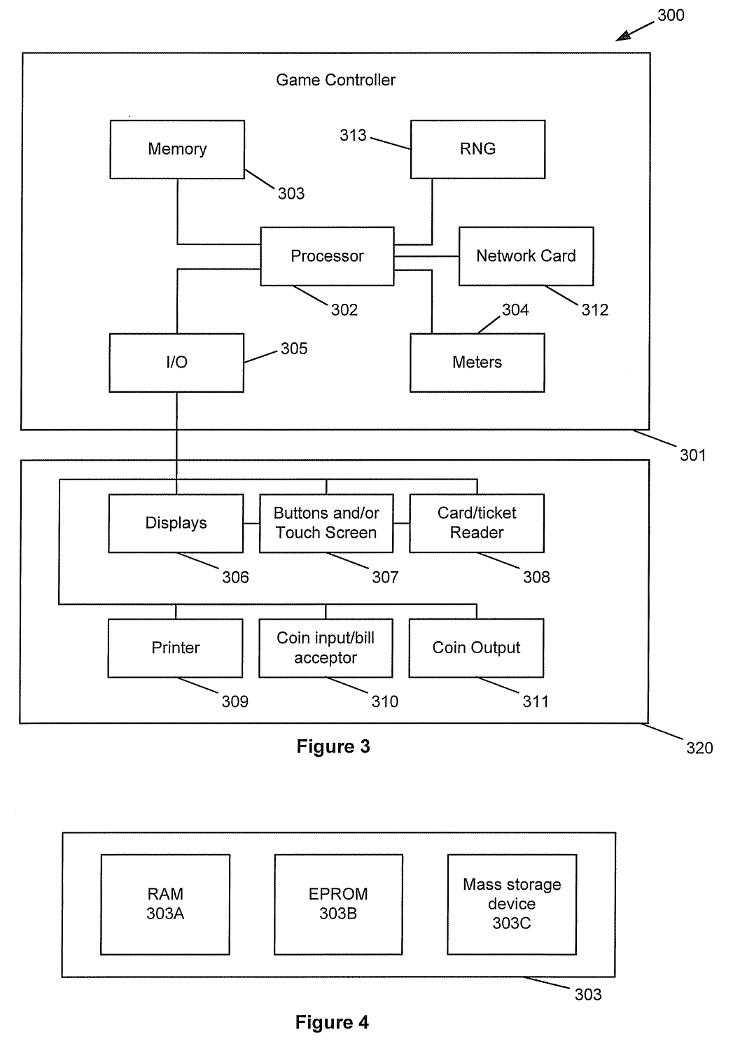

FIG. 3 shows a block diagram of operative components of a typical gaming machine 300 which may be the same as or different to the gaming machine of FIG. 2.

The gaming machine 300 includes a game controller 301 having a processor 302. Instructions and data to control operation of the processor 302 are stored in a memory 303, which is in data communication with the processor 302. Typically, the gaming machine 300 will include both volatile and non-volatile memory and more than one of each type of memory, with such memories being collectively represented by the memory 303.

The gaming machine has hardware meters 304 for purposes including ensuring regulatory compliance and monitoring player credit, an input/output (I/O) interface 305 for communicating with peripheral devices of the gaming machine 300. The input/output interface 305 and/or the peripheral devices may be intelligent devices with their own memory for storing associated instructions and data for use with the input/output interface or the peripheral devices. A random number generator module 313 generates random numbers for use by the processor 302. Persons skilled in the art will appreciate that the reference to random numbers includes pseudo-random numbers.

In the example shown in FIG. 3, a player interface 320 includes peripheral devices that communicate with the game controller 301 comprise one or more displays 306, buttons and/or a touch screen 307, a card and/or ticket reader 308, a printer 309, a bill acceptor and/or coin input mechanism 310 and a coin output mechanism 311. Additional hardware may be included as part of the gaming machine 300, or hardware may be omitted as required for the specific implementation.

In addition, the gaming machine 300 may include a communications interface, for example a network card 312. The network card may, for example, send status information, accounting information or other information to a central controller, server or database and receive data or commands from the central controller, server or database.

FIG. 4 shows a block diagram of the main components of an exemplary memory 303. The memory 303 includes RAM 303A, EPROM 303B and a mass storage device 303C. The RAM 303A typically temporarily holds program files for execution by the processor 302 and related data. The EPROM 303B may be a boot ROM device and/or may contain some system or game related code. The mass storage device 303C is typically used to store game programs, the integrity of which may be verified and/or authenticated by the processor 302 using protected code from the EPROM 303B or elsewhere.

It is also possible for the operative components of the gaming machine 300 to be distributed, for example input/output devices 306, 307, 308, 309, 310, 311 to be provided remotely from the game controller 301.

A gaming device as indicated above may also take the form of a client/server architecture where a portion of the game is executed on the client and a portion of the game is executed on the server. In such embodiments, the client typically takes the form of an interactive video terminal which has a similar outward appearance to the gaming machine described above. A person skilled in the art will appreciate that the type of gaming device that is employed is not important to the present invention.

### Further Detail of the Controller

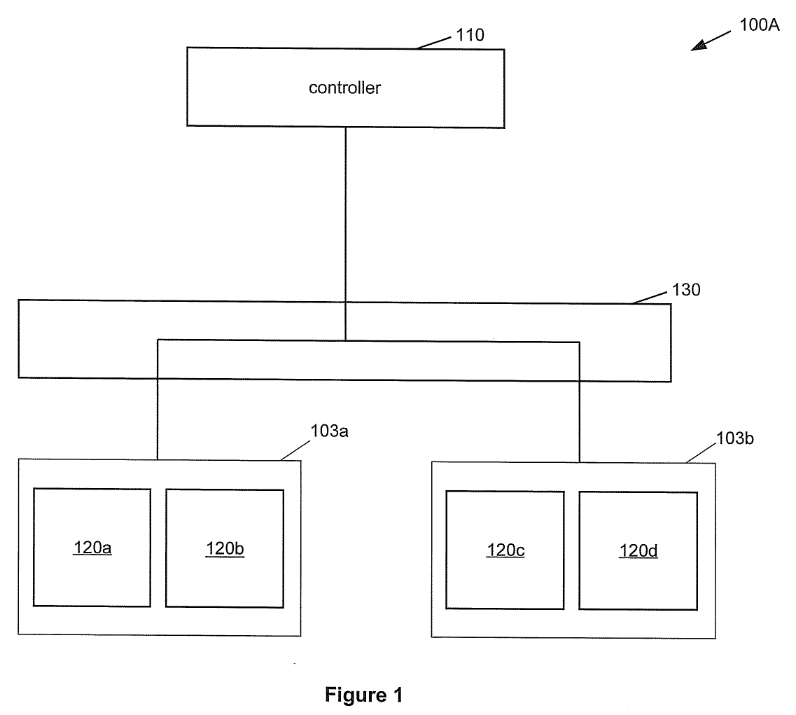

As described in preceding paragraphs, embodiments of the present invention relate to a method, controller and system for promoting a sense of community among players of a group of gaming devices (hereafter gaming machines). Specifically the method involves adjusting award outcomes of at least one of the gaming machines based, at least in part, on a number of other gaming machines that meet a participation criterion. In the following embodiment a controller is utilised to determine how the award outcomes are to be adjusted. The gaming machines of the group communicate with the controller over a network, such as the network previously described with reference to FIG. 1.

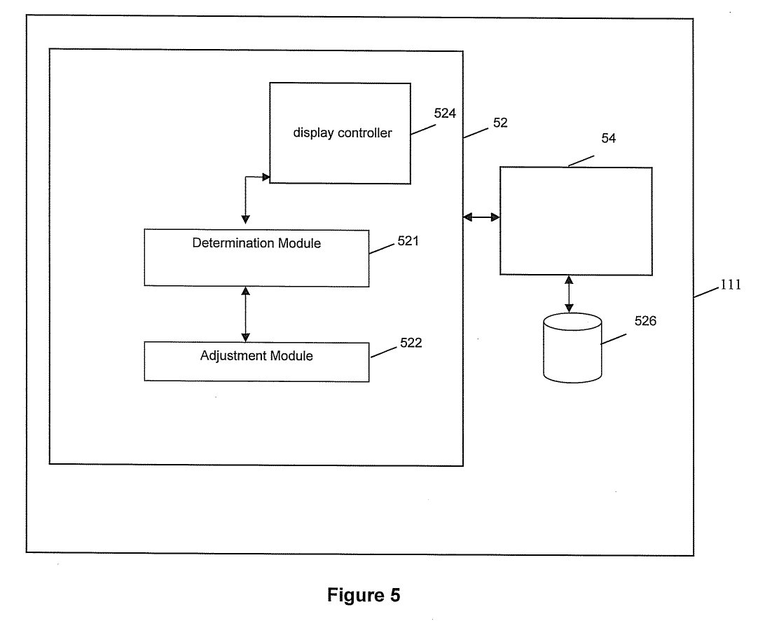

To carry out such functionality, the gaming system 200 comprises a controller 111, as shown in more detail in FIG. 5. According to the described embodiment, the controller 111 is incorporated into a jackpot server 110 of the gaming system 100. For simplicity, only those modules needed to carry out embodiments of the invention are illustrated.

The controller 111 includes a processor 52 which is arranged to carry out the functions associated with adjusting the award outcomes for each gaming machine of the group. It will be apparent that the processor 52 implements a number of modules, namely a determination module 521, adjustment module 522, and display controller module 524, based on program code stored in memory 54.

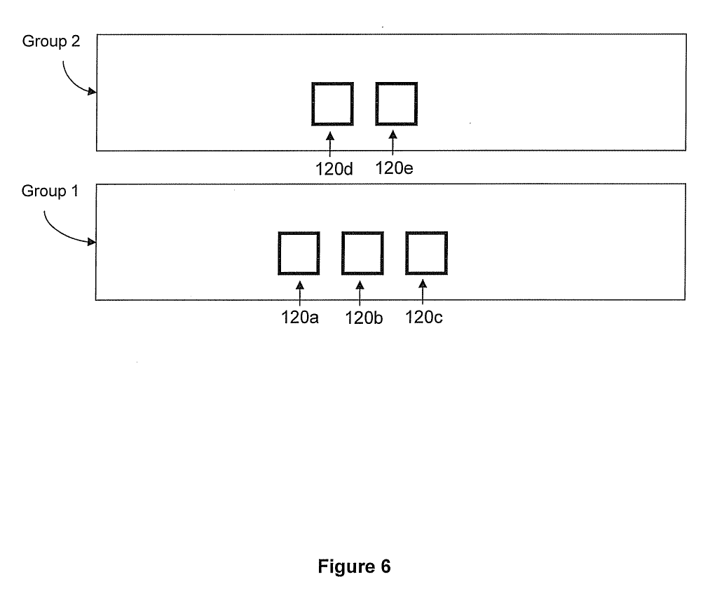

In an embodiment the gaming machines are located in defined groups. The groups can comprise as few or as many gaming machines as required for the particular implementation. For example, a group may comprise two machines located adjacent one another, or as many as a few hundred machines positioned in various locations throughout a gaming hall. A database 526 providing the necessary information to identify each of the gaming machines in a particular group is stored in memory 54. For example, with reference to the example implementation shown in FIG. 6, the groups correspond to the individual machine banks. For this implementation the database 526 could store both the machine identifier and bank position number in association with the group number, as shown below.

| No | Group No. | Identifier | Position |
|---|---|---|---|
| 120a | 1 | 2000021 | 1 |
| 120b | 1 | 2000022 | 2 |
| 120c | 1 | 2000026 | 3 |
| 120d | 2 | 2000024 | 1 |
| 120e | 2 | 2000101 | 2 |

The database 526 is automatically built by the controller 111 using relevant data communicated from the respective gaming machines 120a to 120e during initialisation.

The participation criterion can take a number of different forms. In one embodiment the participation criterion is that a gaming machine is “in play”. This may require, for example, that a game of the gaming machine has been played within a specified time period (e.g. that a game is current, or has finished within a defined time period such as within the last 3 to 10 seconds). Alternatively, the criterion may comprise some other participation related requirement or an additional requirement, such as a number of games played within a defined time period, or an amount bet on the gaming machine (e.g. a maximum bet or an ante bet).

Each gaming machine within a group sends a message to the controller 111 advising as to whether the participation criterion is currently being met. The messages are stored in memory 54 within a participation database 528, which can be referenced by the controller to determine whether the award outcomes need adjusting, as will be described in more detail in subsequent paragraphs. In an alternative configuration, the individual gaming machines could be polled to establish whether the participation criterion is currently being met.

The award outcomes can be adjusted in a number of different ways. In one embodiment, the award outcomes are adjusted by altering the RTP of the individual gaming machines. This can be achieved, for example, by selecting a prize table corresponding to the determined number, from a prize table data set 530 stored in either controller memory 54 or in memory 303 of the individual gaming machines. In alternative embodiments, the award outcomes can be adjusted by adjusting available prizes and/or types of prizes, or modifying the winning odds of the gaming machines. For example, bonus awards may be awarded to each participating gaming machine responsive to determining that another one of the participating gaming machines has triggered a bonus award. The bonus award may take the form of at least one of bonus credits, free games, feature games and coupons. In an embodiment the RTP may return to either its previous setting or a standard setting after a set time period has elapsed. The step of determining whether to adjust the award outcomes can be repeated each time a new game is played by the at least one gaming machine.

It will be understood that the controller can either notify the individual gaming machines of the adjusted award outcomes, or alternatively can be polled to provide such information. Similarly, where the RTP is set using different pay tables, the machines could be either instructed to look up the relevant pay table to use (e.g. table A, B or C) or could be notified of the same by the controller.

### EXAMPLE

Still with reference to FIG. 6, an example implementation for adjusting the RTP of individual gaming machines within a defined group will now be described. In this example, the participation criterion is the “in play” criterion described above. For simplicity, only operation of the first group will be described. The RTP for each of the gaming machines 120 is initially set to a base amount; in this case 87%.

Initially only gaming machine 120a is being played and thus the RTP for that device remains set at the base amount. The controller 111 subsequently detects that a second gaming machine 120b of the group is in play. The controller 111 inspects the RTP database to determine the RTP that is to be applied where two gaming machines are in play and instructs the two participating gaming machines to implement the corresponding RTP (in this case 90%). When either of the gaming machines stops participating, the controller instructs the remaining gaming machine to revert to the base RTP setting.

An indication as to the identity and/or location of the gaming machines which meet are currently meeting the participation criterion can be displayed to players so as to further facilitate interaction there between. In one implementation, the location and/or identity of the participating gaming machines can be advertised on a central display module, or alternatively on the display module of each gaming machine. Similarly, the current RTP setting could also be displayed to players of the gaming machines.

In an alternative example embodiment to that described above, award outcomes are adjusted through awarding bonus prizes to participating gaming machines. For example, responsive to determining that one gaming machine has triggered a bonus prize, each of the other participating gaming machines may also be awarded a prize (either the same prize, or some other prize depending on the desired RTP). In other words, according to such an embodiment the outcome is adjusted by increasing the probability of being awarded a prize. For example, the reel strips of the individual gaming machines may devised such that the probability of triggering a bonus prize is, say, 1 in 140. When two games are in play, the probability may be 1 in 158, which when spread across both machines is 1 in 79.

The bonus award may, for example, be free games. The number of free games awarded to the other participating gaming machines may or may not be the same as that awarded to the triggering machine, depending on the desired RTP.

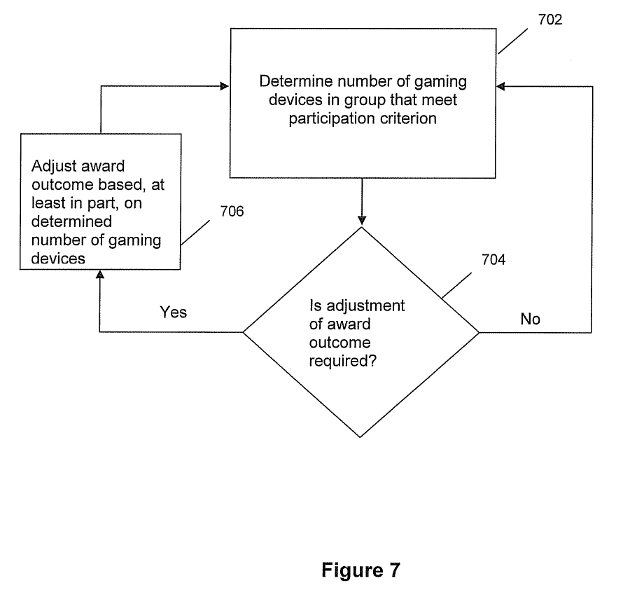

The method according to one embodiment of the invention is summarised in FIG. 7. At step 702 a number of gaming devices which meet a participation criterion is determined. At step 704 it is further determined whether an adjustment of award outcomes is required (e.g. as a result of a determining that a new gaming device meets the participation criterion). If a positive determination is made, at step 706 the award outcome of at least one of the gaming devices is adjusted dependent, at least in part, on the number of other gaming devices that meet the participation criterion. Otherwise, the process returns to step 702.

In the aforementioned embodiments a stand alone controller was utilised to determine the adjusted award outcomes for each of the gaming machines. However, it will be understood by persons skilled in the art, that the controller could equally be integrated into each of the gaming machines. In such an embodiment, game control systems (i.e. individual game controllers) implemented by each of the gaming devices could communicate over any suitable communications medium (e.g. via wireless link or some other fixed communications network, such as the wired network described with reference to FIG. 1) to exchange notification data/signals indicative of whether that gaming device is currently meeting the participation criterion. A game adjustment module implemented by each of the gaming devices is operable to derive the total number of other participating devices from the exchanged signals and adjust the award outcomes accordingly. Alternatively elements of the controller could be split between the gaming machine(s) and controller. For example, the grouping module could be located on the controller side whereas the adjustment module may be located on the gaming machine side.

In yet a further alternative embodiment, in order to be eligible for adjusted award outcomes, players must place an additional wager, or “ante bet”. If, after placing the ante bet, it is established that none of the other gaming machines meet the participation criterion, then the ante bet may be returned to the player. According to such an embodiment, additional prizes paid as a result of the adjusted award outcomes may be funded from a prize pool comprising the ante bet contributions. The value of the adjusted award outcomes may, for example, be proportional to the value of the prize pool.

According to embodiments, award outcomes are adjusted based, at least in part, on the number of gaming machines in the group that meet a participation criterion. For example, in one embodiment, as the number of gaming machines that are being played increases so too does the return to player of each participating gaming device. According to such a technique, the sense of community among players of the group may be promoted and as a result the overall enjoyment experienced by the players may be increased.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming comprising:
determining a number of gaming devices that meet a participation criterion; and
adjusting award outcomes of at least one gaming device which meets the participation criterion dependent, at least in part, on the determined number.

2. A method in accordance with claim 1, wherein award outcomes are adjusted by adjusting one of an expected return to player of the gaming device and a probability of at least one game outcome.

3. A method in accordance with claim 2, wherein the return to player is adjusted by implementing a prize table which corresponds to the determined number of gaming devices.

4. A method in accordance with claim 2, wherein the probability of achieving the at least one game outcome is increased responsive to the number of gaming machines increasing.

5. A method in accordance with claim 1, wherein adjusting award outcomes comprises enabling the gaming device to receive a bonus award from a bonus controller.

6. A method in accordance with claim 5, wherein the bonus award is awarded responsive to determining that another one of the gaming devices has triggered a bonus prize trigger.

7. A method in accordance with claim 5, wherein the bonus award comprises at least one of bonus credits, free games, feature games and coupons.

8. A method in accordance with claim 1, wherein adjusting award outcomes comprises adjusting a bonus award the gaming device receives from a bonus controller

9. A method in accordance with claim 1, wherein the participation criterion is that at least one game has been played within a specified time period.

10. A method in accordance with claim 9, wherein the participation criterion further requires that a current wager amount of the gaming device exceeds a threshold.

11. A method in accordance with claim 1, further comprising repeating the step of determining whether to adjust the award outcome each time a new game is played by the at least one gaming device.

12. A method in accordance with claim 1, wherein the gaming devices are located within either a specified region or number of machines adjacent the at least one gaming device.

13. A controller comprising:
a determining module arranged to determine a number of gaming devices which meet a participation criterion; and
an adjustment module arranged to adjust award outcomes of at least one gaming device which meets the participation criterion dependent, at least in part, on the determined number of gaming devices.

14. A controller in accordance with claim 13, wherein the adjustment module adjusts award outcomes by adjusting one of an expected return to player of the gaming device and a probability of at least one game outcome.

15. A controller in accordance with claim 14, wherein the return to player is adjusted by implementing a prize table which corresponds to the determined number of gaming devices.

16. A controller in accordance with claim 14, wherein the adjustment module increases the probability of achieving the at least one game outcome responsive to the number of gaming devices increasing.

17. A controller in accordance with claim 13, wherein adjusting award outcomes comprises adjusting a bonus award the gaming device receives from a bonus controller.

18. A gaming device operable to communicate with other gaming devices, the gaming device comprising:
a determining module arranged to determine a number of the other gaming devices which meet a participation criterion; and
an adjustment module arranged to adjust an award outcome of the gaming device dependent, at least in part, on the determined number of gaming devices.

19. A gaming system comprising:
a gaming controller in accordance with claim 13; and
two or more gaming devices.

20. A method of gaming comprising the steps of:
determining whether play of a game facilitated by a gaming device meets a participation criterion;
responsive to making a positive determination, outputting a notification signal indicating that the gaming device meets the participation criterion; and
adjusting a characteristic of the game based, at least in part, on a number of the other gaming devices that also meet the participation criterion, the number being derived from notification signals output from the other gaming devices.

21. A method in accordance with claim 20, wherein the gaming device is arranged to processes the notification signals to derive the number.

22. A method in accordance with claim 20, wherein the gaming device is arranged to receive data indicative of either the derived number or an adjustment amount from a controller, in order to adjust the characteristic.

23. A method in accordance with claim 20, wherein the characteristic of the game comprises a statistical return to player.

24. A method in accordance with claim 23, wherein the statistical return to player is adjusted by implementing a prize table which corresponds to the determined number of gaming devices meeting the participation criterion.

25. A method in accordance with claim 23, wherein the statistical return to player is adjusted by awarding the gaming device with a bonus award.

26. A method in accordance with claim 25, wherein the bonus award is awarded responsive to determining that one of the other gaming devices meeting the participation criterion has triggered a bonus prize trigger.

27. A method in accordance with claim 26, wherein the bonus award comprises at least one of bonus credits, free games, feature games and coupons.

28. A method in accordance with claim 20, wherein the participation criterion is that at least one game has been played within a specified time period.

29. A method in accordance with claim 28, wherein the participation criterion further requires that a current wager amount for the game exceeds a threshold.

30. A method in accordance with claim 20, further comprising repeating the step of adjusting a characteristic each time a new game is played by the gaming device.

31. A gaming device comprising:
a game control system arranged to execute game software so as to facilitate play of a game; and
a game adjustment module arranged to:
determine whether play of the game meets a participation criterion; responsive to making a positive determination, output a notification signal indicating that the gaming device meets the participation criterion; and adjust a characteristic of the game based, at least in part, on a number of the other gaming devices that meet the participation criterion, the number being derived from notification signals output from the other gaming devices.

32. A gaming device in accordance with claim 31, wherein the adjustment module is arranged to process the notification signals to derive the number.

33. A gaming device in accordance with claim 31, wherein the game adjustment module is arranged to receive data indicative of either the derived number or an adjustment amount from a controller, in order to adjust the characteristic.

34. A gaming device as claimed in claim 31, wherein the characteristic of the game comprises a statistical return to player.

35. A method according to claim 1 and further including a computer program code which when executed by a processor implements the method.

36. A method according to claim 20 an further including a computer program code which when executed by a processor implements the method.

37. A method according to claim 35 and further including a computer readable medium comprising the program code.

38. A method according to claim 35 and further including a data signal comprising the program code.

39. A method according to claim 35 and further including transmitting the program code.
